(19) United States
(12) Patent Application Publication
(10) Pub. No.: US 2019/0108452 A1
(43) Pub. Date: Apr. 11, 2019

(54) SYSTEM AND METHOD FOR KNOWLEDGE MANAGEMENT

(71) Applicant: General Electric Company, Schenectady, NY (US)

(72) Inventors: Abha Moitra, Scotia, NY (US); Andrew Walter Crapo, Niskayuna, NY (US); Marc Thomas Edgar, Niskayuna, NY (US); Ravi Kiran Reddy Palla, Sunnyvale, CA (US)

(21) Appl. No.: 15/726,638

(22) Filed: Oct. 6, 2017

(51) Int. Cl. G06N 5/04; G06N 5/02

(52) U.S. Cl. CPC G06N 5/046; G06N 5/027

(57) ABSTRACT

A method for knowledge management using concept rules includes receiving event data corresponding to an industrial application and generating at least one inference concept based on the event data. The method also includes obtaining a semantic model having a plurality of inference concepts, a plurality of relationships among the plurality of inference concepts, and a plurality of concept rules representative of domain knowledge. The plurality of concept rules is authored using the plurality of inference concepts and the plurality of relationships. Furthermore, the method includes processing the at least one inference concept based on the semantic model to generate inferential data. The inferential data is representative of an inference corresponding to the event data. In addition, the method includes controlling the industrial application based on the inferential data.

### BACKGROUND

Embodiments of the present specification relate generally to management of domain knowledge, and more particularly to systems and methods for capturing, modelling, and using domain knowledge in industrial applications.

Industrial applications in areas such as the healthcare sector or manufacturing sector require management of domain knowledge. Improper processing of information in such applications may lead to substantial increase in costs. As one example, in the healthcare system, insurance companies may deny reimbursement of medical expenditure claims for reasons such as incomplete data provided by the patients. As another example, in a manufacturing setup, parts specifications may not be reproducible due to infrastructure limitations or lack of process maturity. In such instances, multiple resubmissions of insurance claims or repeated redesigning of parts may be required, thereby necessitating higher costs and prolonged cycle times for industrial processes.

Establishing efficient knowledge management processes requires semantic models representing domain knowledge provided by various stake holders including subject matter experts (SMEs). Domain knowledge is represented in semantic based techniques using one of a variety of description logic languages such as a Web Ontology Language (OWL), which is a recommendation of the World Wide Web consortium (W3C). Capturing requirements from SMEs and encoding the captured requirements into a description language is an iterative process. Also, encoding the captured requirements into the description language involves human interactions and associated problems such as manual review, probability of introduction, and oversight of logical and syntactical errors. Disadvantageously, such errors may not be detectable during early stages such as during development of industrial applications. Such delay in encoding of the captured requirements may lead to undesirable time delays and project costs. Typically, description languages are not natural languages and knowledge encoding requires programming skills. Further, the encoded requirements may not be easily verifiable by the SMEs. Additionally, use of variables in the syntax of rules adversely affects human readability and prevents the SMEs from authoring domain rules.

Recent advances in formal Controlled Natural Languages (CNLs) have improved the process of capturing the requirements in a way such that a subject matter expert (SME) can more easily evaluate and verify the captured requirements. An open source controlled English language called Semantic Application Design Language (SADL) licensed under Eclipse Public License has successfully been used to express constructs of the OWL. SADL also supports rules representative of implications in a First Order Logic (FOL). However, existing CNLs employ syntax that requires use of one or more variables for authoring rules. Inductive logic programming technique is employed to capture domain knowledge. However, SMEs still need to interact with programmers in designing or modifying the semantic model.

### BRIEF DESCRIPTION

In accordance with one aspect of the present specification, a method is disclosed. The method includes receiving event data corresponding to an industrial application and generating at least one inference concept based on the event data. The method also includes obtaining a semantic model comprising a plurality of inference concepts, a plurality of relationships among the plurality of inference concepts and a plurality of concept rules representative of domain knowledge. The plurality of concept rules is authored using the plurality of inference concepts and the plurality of relationships. Moreover, the method includes processing the at least one inference concept based on the semantic model to generate inferential data. The inferential data is representative of an inference corresponding to the event data. Additionally, the method includes controlling the industrial application based on the inferential data.

In accordance with another aspect of the present specification, a system is disclosed. The system includes a data input unit configured to receive event data corresponding to an industrial application. Further, the system includes an inference engine having a semantic model that includes a plurality of inference concepts, a plurality of relationships among the plurality of inference concepts, and a plurality of concept rules representative of domain knowledge. The plurality of concept rules is authored using the plurality of inference concepts and the plurality of relationships. The inference engine further includes a knowledge encoder unit communicatively coupled to the data input unit and configured to generate at least one inference concept based on the event data. The inference engine also includes an evaluation unit communicatively coupled to the knowledge encoder and configured to process the at least one inference concept based on the semantic model to generate inferential data. The inferential data is representative of an inference corresponding to the event data. In addition, the system includes an output unit communicatively coupled to the inference engine and configured to control the industrial application based on the inferential data.

In accordance with another aspect of the present specification, a non-transitory computer readable medium having instructions to enable at least one processor unit is disclosed. The instructions enable the at least one processor unit to receive event data corresponding to an industrial application and generate at least one inference concept based on the event data. Moreover, the instructions enable the at least one processor unit to obtain a semantic model comprising a plurality of inference concepts, a plurality of relationships among the plurality of inference concepts, and a plurality of concept rules representative of domain knowledge. The plurality of concept rules is authored using the plurality of inference concepts and the plurality of relationships. Also, the instructions enable the at least one processor unit to process the at least one inference concept based on the semantic model to generate inferential data. The inferential data is representative of an inference corresponding to the event data. The instructions also enable the at least one processor unit to control the industrial application based on the inferential data.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of a system for knowledge management, in accordance with aspects of the present specification;

FIG. 2 is a flow chart of a method for knowledge management, in accordance with aspects of the present specification;

FIG. 3 is a schematic illustrating intermediate knowledge representation formats employed in the system of FIG. 1, in accordance with aspects of the present specification;

FIG. 4 illustrates an integrated development environment (IDE) interface for authoring a concept rule, in accordance with aspects of the present specification; and

FIG. 5 illustrates a translation window in the IDE, in accordance with aspects of the present specification.

### DETAILED DESCRIPTION

As will be described in detail hereinafter, systems and methods for management of domain knowledge are presented. More particularly, systems and methods for capturing, modelling, and utilizing domain knowledge in industrial applications are presented.

The term “semantic web” refers to a web of data that can be processed directly or indirectly by machines. The term “semantic model” refers to one or more logical and mathematical expressions formulated from variables representative of inference concepts, relationships, and rules. The semantic web organizes information and enables knowledge processing using ontology based semantic models incorporating web resources. The term “industrial application” as used herein refers to an application related to an industrial system such as a healthcare management system or a manufacturing system. The term “knowledge management system” as used herein refers to an analytical engine or an inference engine used in the industrial application.

Further, the term “ontology” refers to a specification of a plurality of inference concepts along with relationships between two or more of the plurality of inference concepts. In object-oriented programming, ontologies may be considered as domain classes having logical statements describing inference concepts, their properties, and relationships between the inference concepts. Tools referred to herein as reasoners, are employed by the semantic web to process rules to perform advanced queries and extract implicit relationships among resources. The term “ontology language” refers to a formal language used for constructing ontologies. An ontology is a formal explicit specification of a shared conceptualization of a domain of interest. Ontology languages are capable of encoding knowledge about specific domains and including reasoning rules that support processing of domain specific knowledge. Ontology languages may be interchangeably and equivalently referred as “declarative languages.” The term “first order logic” or “FOL” refers to a prepositional logic combined with objects, properties, relations, and functions.

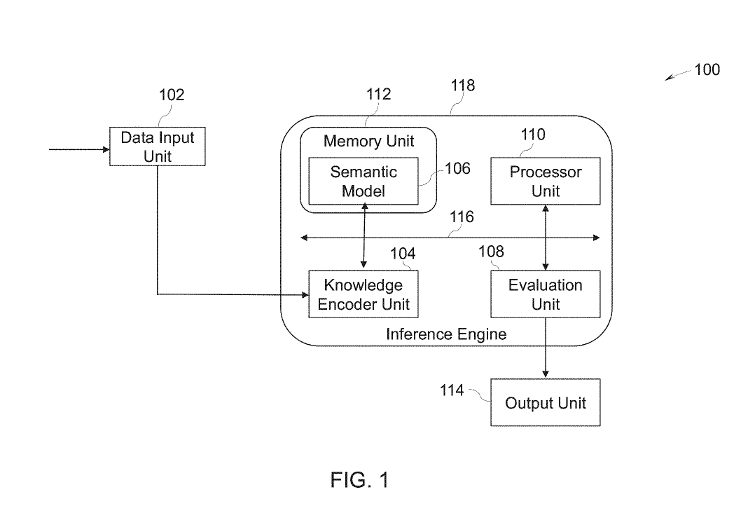

FIG. 1 is a diagrammatic illustration of a system 100, in accordance with aspects of the present specification. The system 100 may be a knowledge management system that is configured to enable a subject matter expert (SME) to author rules required for knowledge processing. As an example, the knowledge management system 100 may be representative of a healthcare management system having an insurance claim processing application. The insurance claim processing application is based on semantic models and has deep analytical insights. In another example, the knowledge management system may be representative of a manufacturing system such as an avionics manufacturing system. The avionics manufacturing system may include application configured to evaluate parts specifications for design alignment and manufacturing capability. In other embodiments, the system 100 may be a standalone inference engine or a domain specific decision support system having a knowledge processing subsystem 118.

In a presently contemplated configuration, the system 100 includes a data input unit 102, the knowledge processing subsystem 118, and an output unit 114. The knowledge processing subsystem 118 includes a knowledge encoder unit 104, a semantic model 106, an evaluation unit 108, a processor unit 110, and a memory unit 112. The various components of the knowledge processing subsystem 118 may be interconnected with each other by a communications bus 116. The communication bus 116 may represent a wired or wireless connection.

The data input unit 102 is configured to receive event data from a user. The data input unit 102 may be a part of an integrated development environment (IDE) used to design and implement the knowledge management system 100. In an embodiment where the industrial application is a healthcare system, the event data may be a reimbursement claim submission. In an embodiment where the industrial application is a manufacturing system, the event data may be a specification of a part to be manufactured. The data input unit 102 may be a keyboard, a display, a file reader, a microphone, a video camera, or any other suitable input device, or combinations thereof. The event data may be either processed in real-time by the knowledge processing system 118 or stored in the memory for off-line processing.

In one embodiment, the data input unit 102 is also configured to receive domain knowledge from one or more subject matter experts (SMEs) for example, using natural languages. The data input unit 102 is also configured to accept declarations using keywords, phrases, and prepositions as first-order logical statements. In one embodiment, the data input unit 102 is configured to assist the user in authoring concept rules involving inference concepts and relationships related to a specific domain of knowledge. In particular, the data input unit 102 enables the SMEs to author concept rules using a ‘Crule language.’ The term ‘Crule language’ is used herein to refer to a rule authoring language based on natural language constructs without the need of using variables. The Crule language includes constructs such as, but not limited to, cardinality, disjunction, chaining of relations, and existential quantifier to represent complex knowledge in the rules. Consequently, the SMEs are not required to use variables while capturing domain knowledge and authoring the concept rules.

The concept rules are representative of domain knowledge. In one example, in the domain of education, inference concepts such as ‘Professor,’ ‘Administrator,’ and ‘Class’ are employed. Further, a plurality of properties such as ‘teaching’ and ‘availableToTeach’ are also employed. The domain of education is also defined by a plurality of relationships between a plurality of education related topics. Specifically, a domain specific rule such as a condition of availability of a ‘Professor’ to teach a ‘Class’ to be authored by a subject matter expert (SME) may be expressed as “if a professor teaches a class and the professor is not an administrator then that professor is available to teach another class.”. When the SME starts authoring the rule via the data input unit 102, a concept rule characterizing the domain specific rule is represented as:

Rule Professor-Classes:
if a Professor teaches a Class and

the Professor is not an Administrator

then

the Professor is availableToTeach another Class

In the example of the domain specific rule, Professor-Classes is the name of the rule. Also, the italicized words are fillers and keywords, and the other words are concepts and properties. The SME may specify a name for the rule such as ‘Professor-Classes.’ The data input unit 102 may assist the SME in authoring rules by analyzing the text already entered through the data input unit 102. In one embodiment, the data input unit 102 may be provided with a library of keywords and syntax to use the keywords usable for authoring concept rules. Further, the data input unit 102 may also provide indentations on a display used by the SME to author the rules. In one embodiment, the data input unit 102 may be provided with a text parsing software for analyzing the text entered by the SME and assisting the SME to author rules. The text parsing software may also be configured to verify the syntax of the rules and accept the rules after confirmation by the SME. In one embodiment, the SME may complete authoring a concept rule and submit the concept rule to be stored in the memory unit 112 as part of the semantic model 106.

The knowledge encoder unit 104 is communicatively coupled to the data input unit 102 and configured to receive the concept rule from the memory unit 112 and the event data from the data input unit 102 or from the memory unit 112. The knowledge encoder unit 104 is configured to generate a description language version of the concept rule based on a description logic language. In one embodiment, the knowledge encoder unit 104 is configured to process the event data received from the data input unit 102 and generate at least one inference concept based on the event data. In certain embodiments, the knowledge encoder unit 104 is configured to generate one or more inference concepts and one or more relationships based on the event data. It may be noted that the generated one or more inference concepts is a subset of the plurality of inference concepts and the generated one or more relationships is a subset of the plurality of relationships provided by or stored in the semantic model 106.

Further, the knowledge encoder unit 104 is also configured to process the text entered by the user or text stored in the memory unit 112 using a natural language processing technique. In one embodiment, the knowledge encoder unit 104 is configured to parse the received concept rule. Moreover, the knowledge encoder unit 104 is also configured to translate the concept rule specified by the user into the description logic language based on the parsed text. In one embodiment, Semantic Application Design Language (SADL) is used to represent rules. In another embodiment, PROLOG, a general purpose logic programming language is used to represent rules and other user requirements. For example, the concept rule Professor-Classes presented hereinabove is represented in SADL as:

Rule Professor-Classes:
if p1 is a Professor and

c1 is a Class and
p1 teaches c1 and
p1 is not an Administrator and
c2 is a Class and
c1 != c2

then

p1 is availableToTeach of c2.

where, the terms p1, c1, and c2 are variables.

In some embodiments, the knowledge encoder unit 104 may include a plurality of translators. In some of these embodiments, the user may be required to specify a preferred translator among the plurality of translators based on compatibility of system hardware and legacy software components. In one embodiment, the plurality of translators may include one or more of a SADL translator, a PROLOG translator, and the like.

The semantic model 106 refers to a domain knowledge represented as a plurality of inference concepts, a plurality of relationships among two or more of the plurality of inference concepts, a plurality of rules for processing the inference concepts, and relationships, and combinations thereof. An existing domain specific ontology is used to develop the semantic model 106 based on description logic syntax. The domain specific ontology may be shared across systems in a specific domain and may be prepared or updated in a collaborative way by a SMEs. In a non-limiting embodiment, a semantic modelling language includes one or more of SADL and OWL. The semantic model 106 is generated by integrating logical inference provided by the ontology and the rule-based inference specified by the SMEs.

The evaluation unit 108 is communicatively coupled to the knowledge encoder unit 104 and the semantic model 106 and configured to process the at least one generated inference concept based on the semantic model 106 to generate an inferential data. In one embodiment, the inferential data may include a recommendation by the semantic model 106 to the user for suitably modifying the event data. In the example of the healthcare system, the recommendation may suggest modification to one or more aspects of an insurance claim to reduce or minimize denial of the insurance claim. In another embodiment, the inferential data may include an evaluation report on manufacturability of a part specification. The evaluation unit 108 is further configured to modify the semantic model 106 based on the inferential data and a corresponding desired inferential data. The desired inferential data may be available from a user or a memory location. The desired inferential data corresponds to expected inferential data from the semantic model 106. The evaluation unit 108 is configured to process the event data through the use of the one or more generated inference concepts based on the semantic model 106. The processing of the event data may also include use of one or more generated relationships derived by the knowledge encoder unit 104.

The output unit 114 is communicatively coupled to the evaluation unit 108 and configured to present the inferential data to an industrial application or to a user. In one embodiment, the output unit 114 is configured to control the industrial application based on the inferential data. Specifically, the output unit 114 may retrieve one or more recommendations corresponding to the event data from the inferential data based on desired inferential data. The recommendations are generally representative of suggestions to modify the event data or actions to modify some aspect of the knowledge management system. Further, the output unit 114 is configured to modify the event data based on the recommendation. In the application of a manufacturing system, the output unit 114 may process the inferential data to retrieve a recommendation such as an indication of a design change and one or more parameters to be considered by a computer-aided design (CAD) designer for modifying the design. In an insurance approval system, the output unit 114 may process the inferential data to retrieve a recommendation such as a binary variable indicating an approval or a denial decision about an insurance claim. In one embodiment, the output unit 114 may generate recommendations to modify a medical reimbursement claim. The recommendation may include suggestions of additional documents to be provided and/or procedural steps to be followed while preparing or resubmitting the insurance claim.

The processor unit 110 includes at least one of a general-purpose computer, a graphics processing unit (GPU), a digital signal processor, and a controller. In other embodiments, the processor unit 110 includes a customized processor element such as, but not limited to, an application-specific integrated circuit (ASIC) and a field-programmable gate array (FPGA). In some embodiments, the processor unit 110 may perform one or more functions of at least one of the knowledge encoder unit 104, the evaluation unit 108, and the data input unit 102. In one embodiment, the processor unit 110 may be configured to receive commands, parameters from an operator via a console that has a keyboard or a mouse or data from the data input unit 102. The processor unit 110 may also be configured to receive clauses of a concept rule from the data input unit 102 and store the clauses of the concept rules in the memory unit 112. The processor unit 110 may include more than one processor co-operatively working with one another for performing intended functionalities. The processor unit 110 is further configured to store and retrieve contents into and from the memory unit 112. In one embodiment, the processor unit 110 is configured to initiate and control the functionality of at least one of the data input unit 102, the knowledge encoder unit 104, and the evaluation unit 108.

In one embodiment, the memory unit 112 may be a random-access memory (RAM), read only memory (ROM), flash memory or any other type of computer readable memory accessible by at least one of the data input unit 102, the knowledge encoder unit 104, and the evaluation unit 108. The memory unit 112 is also configured to store the semantic model 106 corresponding to the industrial application. In one embodiment, the memory unit 112 may be a non-transitory computer readable medium encoded with a program having a plurality of instructions to instruct at least one of the data input unit 102, the knowledge encoder unit 104, and the evaluation unit 108 to perform a sequence of steps to generate the inferential data corresponding to an industrial application. The program may be used to further instruct the processor unit 110 to control the industrial application.

In one embodiment, a non-transitory computer readable medium is encoded with instructions that enable the processor unit 110 to assist SMEs to author domain rules. The instructions enable the processor unit 110 to receive event data corresponding to an industrial application from the data input unit 102. Further, the instructions enable the processor unit 110 to perform the functionality of the knowledge encoder unit 104. The instructions enable the processor unit 110 to parse the event data to generate one or more inference concepts and instance relationships. The instructions are also configured to evaluate the one or more inference concepts and instance relationships to determine an inferential data by performing the functions of the evaluation unit 108. In one embodiment, the instructions enable the processor unit 110 to accept new concept rules authored by the SME, update the semantic model 106, generate an inferential data, and control the industrial application based on the inferential data.

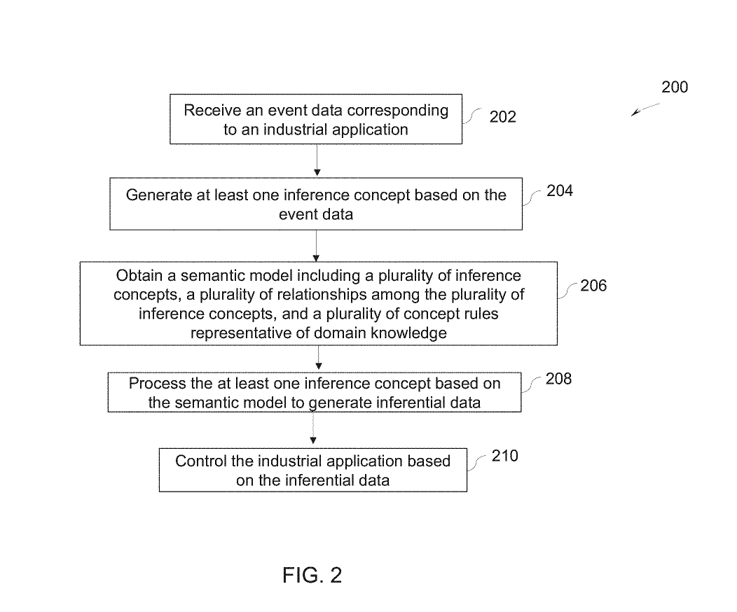

FIG. 2 is a flow chart of a method 200 for knowledge management, in accordance with aspects of the present specification. The method includes receiving event data, as indicated by step 202. In one embodiment, the event data may correspond to an industrial application. In one example, the industrial application is a manufacturing system for evaluating producibility of parts based on specified features. In another embodiment, the industrial application is an insurance approval system evaluating medical reimbursement claims. In a non-limiting example, the event data corresponding to the manufacturing system includes a part specification from a computer-aided design (CAD). In another non-limiting example, the event data corresponding to the insurance approval system includes a medical reimbursement claim submitted on behalf of the patient. The event data is received by the data input unit 102 of FIG. 1, where the data input unit 102 may include a keyboard, a display, a mouse, a microphone, a video camera, or combinations thereof. In one embodiment, the data input unit 102 may also be a part of an integrated development environment (IDE) assisting a subject matter expert (SME) to author concept rules used for processing the event data to generate the inferential data.

The method further includes obtaining a semantic model, such as the semantic model 106 of FIG. 1, as illustrated by step 204. In one embodiment, the semantic model is generated off-line and stored in the memory. The semantic model includes a plurality of inference concepts, a plurality of relationships among the plurality of inference concepts, and a plurality of concept rules. The semantic model is configured to generate one or more inferences corresponding to the industrial application. The plurality of concept rules is authored by the SME. In one embodiment, the semantic model includes the plurality of concept rules in one or more formats such as, but not limited to, a semantic application design language (SADL), a web ontological language (OWL), a Jena rules language, or a Crule language. In one embodiment, the semantic model is updated based on the event data and the inferential data. The SME may be provided with the inferential data and corresponding event data for review. Based on the review, SME may author one or more concept rules. The authored concept rules are used to modify the semantic model. In one embodiment, the authored concept rules may be added to the semantic model. In another embodiment, the authored concept rules may replace existing concept rules in the semantic model.

The method at step 206, includes generating at least one inference concept based on the event data. The generation of at least one inference concept is performed by knowledge encoder unit 104 of FIG. 1. Moreover, the generation of at least one inference concept includes parsing of the event data. Further, one or more relationships are also generated during parsing of the event data.

Also, the at least one generated inference concept is processed based on the semantic model 106 to generate inferential data, as indicated by step 208. At step 208, clauses of a concept rule are evaluated by performing one or more knowledge processing steps to generate the inferential data. Processing of the at least one generated inference concept includes parsing of clauses of a concept rule to generate inference concepts, relationships, and keywords. The parsing further includes identification and removal of filler words in the clauses. The parsing also includes associating the inference concepts and the relationships with knowledge processing steps directed by keywords.

In one embodiment, the processing of step 208 includes generating the inferential data by processing the event data via evaluating the concept rule using one or more generated inference concepts and one or more generated relationships. The evaluation unit 108 of FIG. 1 may be used to perform step 208. In one embodiment, the processing may include generating a recommendation to modify the event data based on the generated inferential data and desired inferential data. As previously noted, the desired inferential data corresponds to expected inferential data from the semantic model and may be available from a user or in a memory location. In the embodiments disclosed herein, the parsing of the event data is performed based on a natural language processing technique. Further, the inferential data may include the recommendation to modify the event data derived based on the event data.

The method also includes controlling the industrial application based on the inferential data, as depicted in step 210. In the application of the manufacturing system, the processor unit 108 may generate an indication to the CAD designer to modify a design of a part. In another embodiment, controlling the industrial application may include generating parameters or aspects to be modified in the CAD design before proceeding towards subsequent steps of manufacturing. In the insurance approval system, controlling includes an approval or a denial decision about an insurance claim. In one embodiment, controlling the industrial application includes generating recommendations to modify the medical reimbursement claim with suggestions of additional documents to be provided and/or procedural steps to be followed.

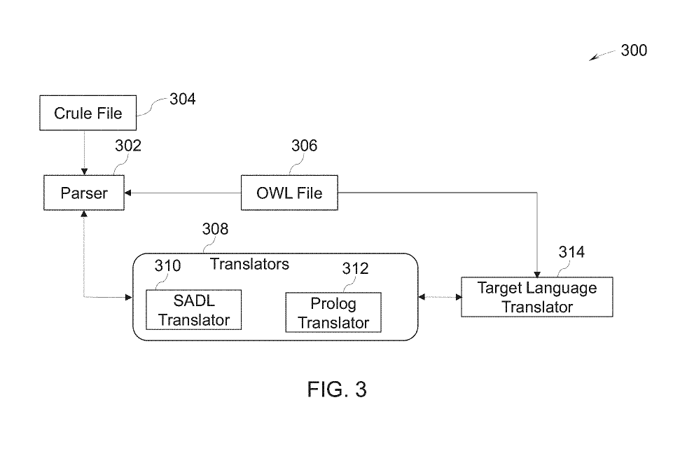

FIG. 3 is a schematic 300 illustrating intermediate knowledge representation formats employed in the system 100 of FIG. 1, in accordance with aspects of the present specification. FIG. 3 is described with reference to the components of FIG. 1.

The schematic 300 includes a parser 302 configured to parse a plurality of concept rules of the semantic model 106 of FIG. 1. The parsing of concept rules is performed based on a library of keywords and Crule language constructs. In one embodiment, the parsing includes identification and subsequent removal of filler words from the concept rule description. The parser 302 is provided with a Crule language file 304 having a plurality of concept rules. The Crule language enables an SME to author domain knowledge based rules for use by an inference engine. The parser 302 is configured to receive OWL file 306 representative of a semantic web ontology. In one embodiment, the parsed concept rule is translated to one of a plurality of description logic languages such as, but not limited to, SADL and a PROLOG language. Web semantic language enables representation of a semantic model and the SADL language enables compilation of rules useful for generating inference about an industrial application.

The schematic 300 also includes a plurality of translators 308 such as a SADL translator 310 and a PROLOG translator 312. It may be noted that the SADL translator 310 is configured to introduce one or more variables in an SADL rule so that the concept rule may be handled by existing knowledge based platforms. In one embodiment, choice of a description language translator is specified by a user.

In another embodiment, the choice of the descriptor language translator is determined based on at least one of a target language and software platform used by the inference engine. By way of example, the knowledge management system 100 built using SADL and a Jena engine uses an SADL translator.

Further, the schematic 300 includes a target language translator 314 configured to translate the description logic language rules to a target language based on the OWL file 306. In one embodiment, the SADL rules are translated to Jena rules by a Jena translator. It may be noted that in one embodiment, the target language rules may be translated to one of the description logic language rules by the target language translator. In another embodiment, the description logic language rules may be translated to a concept rule by a corresponding description language translator.

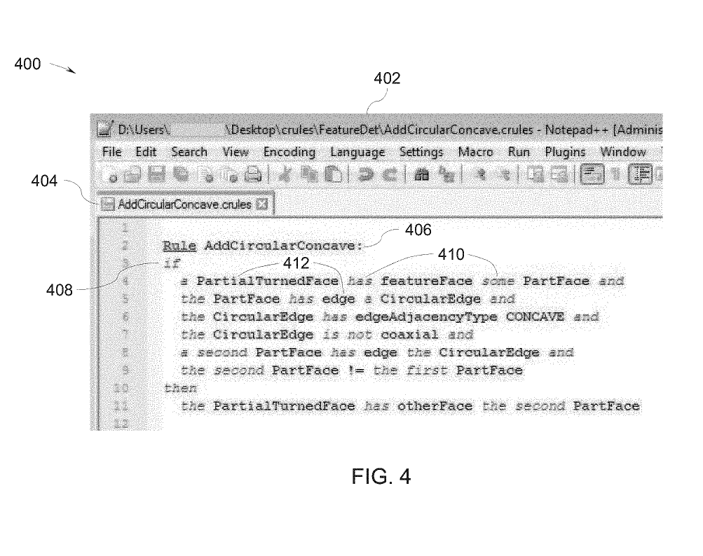

FIG. 4 illustrates an integrated development environment (IDE) interface 400 for authoring a concept rule, in accordance with aspects of the present specification. An advanced text editor may be configured to author clauses in a Crule language that enables an SME to author rules without requiring familiarity of syntax of description languages. The advanced text editor may further be configured to provide coloring and indentation to clauses of the Crule language. The advanced text editor may also be configured to provide content assistance to the SME for authoring rules.

In the illustrated embodiment of FIG. 4, the IDE 400 includes a concept rule authored in a text editor 402 and stored in a file 404 with a ‘crules’ extension. The example of the concept rule includes a rule name 406 and a body including a plurality of rule statements. The rule statements include control words 408 defining the rule, a plurality of relational words 410, and a plurality of conceptual words 412. Also, in the illustrated example, the concept rule corresponds to a manufacturing system that verifies producibility of parts based on part specifications. The concept rule is named as AddCircularConcave, which is a part of a series of rules to identify faces that are more cost-effective to manufacture. The manufacturing system includes sixty-seven feature detection rules and all of them are authored using the Crule language. In one embodiment, semantics of the Crule language is based on Datalog+/−. The Datalog+/− is a family of Datalog languages having a framework for tractable ontology querying.

As another example in the manufacturing system, a concept rule for identifying a pad fillet is given as:

Rule findPadFillet1:
if a BlendingFace has edge an IntersectionEdge

with edgeAdjacencyType TANGENT and

the BlendingFace has edge a second IntersectionEdge

with edgeAdjacencyType TANGENT and

the first IntersectionEdge != second IntersectionEdge and
the second IntersectionEdge has connectedFaces a PartFace and
the PartFace is a CylindricalFace or ConicalFace and
the PartFace is not concave and
the PartFace is floorFace and
a second PartFace has edge the first IntersectionEdge and
the second PartFace != the BlendingFace and
the second PartFace != the first PartFace and
the second PartFace does not sharesVertex

with the first PartFace and

the second PartFace has edge a Part Edge

with edgeAdjacencyType CONVEX and

the PartEdge != the first IntersectionEdge

then
there exists a PadFillet
satisfying (PadFillet has featureFace the BlendingFace)
such that

{PadFillet has otherFace the second PartFace and
PadFillet has bottomFace the first PartFace and
PadFillet has bottomEdge the second IntersectionEdge and
PadFillet has featureName “Pad Fillet”}

where findPadFillet1 in the header (first line) of the concept rule is the name of the rule, the words in italics are fillers and keywords, and the other words in the body (second line onwards) of the concept rule are domain specific inference concepts and relationships.

In one embodiment, the Crule language constructs are formulated to enable avoiding use of variables in authoring rules. Within a rule, the indefinite articles ‘a’ and ‘an’ are used to introduce a concept or a relationship, and the definite article ‘the’ is used to refer to the same concept or relationship subsequently within the rule. As an example, in the rule of findPadFillet1, a first instance of the concept is recited as ‘a BlendingFace’ in the second line, and subsequent instances of the concept are recited as ‘the BlendingFace’ in the fourth line, the twelfth line, and the twentieth line. In one embodiment, multiple instances of the same type are distinguished by referring to the first instance as ‘a first . . . ’, the second instance as ‘a second . . . ,’ and so on. Subsequent references to the same instances may take the form of ‘the first . . . ’, ‘the second . . . ,’ and the like. When there are two instances of the same type, the second one may be referred to as ‘another’ for the first time. In the example of findPadFillet1 rule, a first PartFace is referred as ‘a PartFace’ on line seven and as a second PartFace is referred to as ‘a second PartFace’ on line eleven.

It may be noted herein that the same rule may be authored in Crule language in different ways. These different Crule language formats may be translated to the same rule in a description language. For example, the clause ‘a PartialTurnedFace has featureFace some PartFace’ may also be authored as ‘a PartialTurnedFace has featureFace a PartFace’. In some instances, two clauses of a rule may be combined as a single clause. As an example, the clauses ‘the PartFace has edge a CircularEdge’ and ‘the CircularEdge has edgeAdjacencyType CONCAVE’ may be combined in a single clause as ‘the PartFace has edge a CircularEdge with edgeAdjacencyType CONCAVE.’

The Crule language is configured to accommodate disjunction in a natural way in contrast to Jena and other semantic web rules languages. As an example, on line eight of the ‘findPadFillet1’ rule, “PartFace is a CylindricalFace or ConicalFace” is representative of a disjunction which gets translated to an ‘oneOf’ construct of the SADL. The Crule language is further configured to represent the getInstance( . . . ) construct of SADL as ‘there exists’ which is easily relatable to first order logic. The Crule language is also configured to represent the ‘countMatches’ construct of SADL by defining a property ‘sharesVertex.

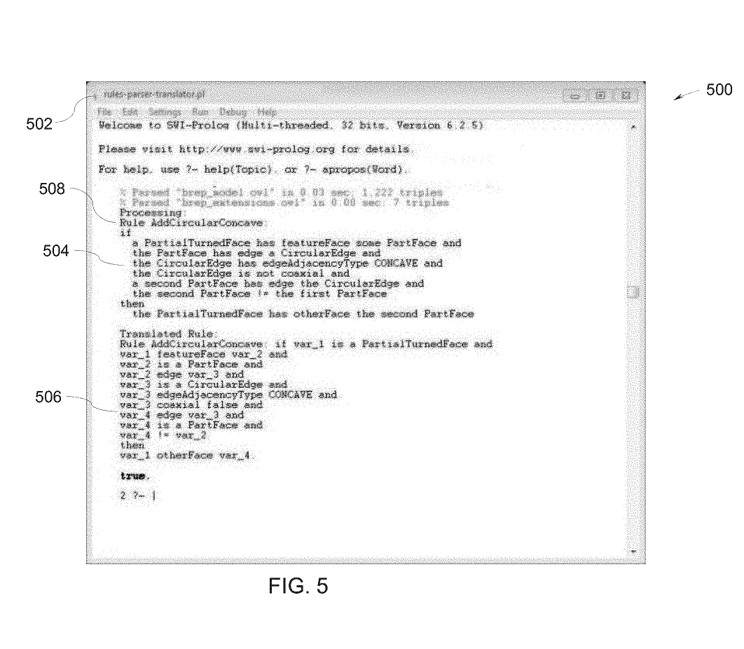

FIG. 5 illustrates a translation window 500 in an IDE such as the IDE 400 of FIG. 4, in accordance with aspects of the present specification. The translation window 500 may be presented as a text window 502 and is configured to translate a concept rule to a description logic representation of the concept rule of FIG. 4. The translation window 500 includes a concept rule 504 reproduced from FIG. 4. Further, the translation window 500 also includes an SADL rule 506 which is an SADL version of the concept rule 504. The concept rule 504 and the SADL rule 506 are represented by the same name 508. The description logic representation in the translation window 500 includes a plurality of variable names 510 embedded in the SADL rule 506.

As another example, an SADL version of the concept rule ‘findPadFillet1’ is given by:

Rule findPadFillet1:
if

fface is a BlendingFace
fface has edge oedge
oedge has edgeAdjacencyType TANGENT
oedge is a IntersectionEdge
fface has edge bedge
oedge != bedge
bedge has edgeAdjacencyType TANGENT
bedge is a IntersectionEdge
bedge has connectedFaces bface
concave of bface is false
floorFace of bface is true
bface is a t1
oneOf(t1, CylindricalFace, ConicalFace)
oedge has connectedFaces oface
fface != oface
oface != bface
countMatches(oface, edge, xe1, xe1, vertex, xv1,

bface, edge, xe2, xe2, vertex, xv1) = 0

oface has edge e3
e3 != oedge
e3 has edgeAdjacencyType CONVEX
fillet1 = getInstance(PadFillet, featureFace, fface)

then

otherFace of fillet1 is oface
bottomFace of fillet1 is bface
bottomEdge of fillet1 is bedge
featureName of fillet1 is “Pad Fillet”.

where words in bold are representative of variables and other words are representative of inference concepts, keywords, relationships, and filler words.

The SADL version of the concept rule includes disjunction construct ‘oneOf( ),’ a construct getInstance( ), and a construct countMatches( ), which were more intuitively expressed in the Crule language.

In one embodiment, the Crule language is configured as a controlled natural language (CNL) enabling the SMEs to represent domain knowledge. A framework, referred herein as PENS framework, for classifying and comparing the controlled natural languages (CNLs) on four parameters of precision, expressiveness, naturalness, and simplicity on a scale of 1 to 5 is used to characterize the CNLs. The Crule language is characterized as being P⁵E³N⁵S⁴ indicating a highest score of 5 for precision and naturalness, a score of 4 for simplicity, and a good score of 3 for expressiveness. In comparison, the English language is characterized as P¹E⁵N⁵S¹, propositional logic is classified as P⁵E¹N¹S⁵, Attempto controlled language (ACE) is classified as P⁴E³N⁴S³, and SADL is characterized as P⁵E³N⁴S⁴. It may be noted that the Crule language receives higher scores for individual parameters and receives a higher average score compared to other conventional controlled natural languages.

The technical effect of the disclosed systems and methods is that domain knowledge in a knowledge based system is accurately represented in an efficient manner. The disclosed systems and methods enable a subject matter expert to interact with the knowledge based system to author knowledge processing rules without requiring training in descriptive programming languages or assistance from programmers. This feature in a knowledge processing system reduces delay in modifying the knowledge base to include most recently acquired knowledge and insights to process the domain knowledge. Disclosed embodiments of the knowledge management system employ natural language based Crule language to author rules in a natural way. New rules may be added or existing rules in the knowledge management system may be modified in shorter time periods at reduced cost. The concept rules captured are independent of the target executable rule language. Reuse of domain expertise and deployment of domain knowledge across apparently different knowledge systems becomes easier.

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the specification may include only some of the described embodiments. Accordingly, the specification is not to be seen as limited by the foregoing description, but is only limited by the scope of the appended claims.

1. A method, comprising:
receiving event data corresponding to an industrial application;
generating at least one inference concept based on the event data;
obtaining a semantic model comprising a plurality of inference concepts, a plurality of relationships among the plurality of inference concepts, and a plurality of concept rules, wherein the plurality of concept rules is representative of domain knowledge, and wherein the plurality of concept rules is authored using the plurality of inference concepts and the plurality of relationships;
processing the at least one inference concept based on the semantic model to generate inferential data, wherein the inferential data is representative of an inference corresponding to the event data; and
controlling the industrial application based on the inferential data.

2. The method of claim 1, wherein the plurality of concept rules is authored without using variables.

3. The method of claim 1, wherein obtaining the semantic model comprises:
assisting a subject matter expert in authoring a concept rule among the plurality of concept rules; and
incorporating the authored concept rule in the semantic model.

4. The method of claim 1, wherein obtaining the semantic model comprises translating one or more concept rules among the plurality of concept rules to a description logic language.

5. The method of claim 4, wherein translating the one or more concept rules comprises representing the one or more concept rules in a semantic application design language (SADL), a PROLOG language, or a combination thereof.

6. The method of claim 4, wherein translating the one or more concept rules further comprises representing the one or more concept rules in a target language.

7. The method of claim 6, wherein the target language comprises a Jena rules language.

8. The method of claim 1, wherein generating the at least one inference concept comprises parsing the event data based on a natural language processing technique.

9. The method of claim 1, wherein controlling the industrial application comprises:
retrieving a recommendation corresponding to the event data from the inferential data based on desired inferential data; and
modifying the event data based on the recommendation.

10. A system, comprising:
a data input unit configured to receive event data corresponding to an industrial application;
an inference engine comprising:
a semantic model comprising a plurality of inference concepts, a plurality of relationships among the plurality of inference concepts and a plurality of concept rules, wherein the plurality of concept rules is representative of domain knowledge, and wherein the plurality of concept rules is authored using the plurality of inference concepts and the plurality of relationships;
a knowledge encoder unit communicatively coupled to the data input unit and configured to generate at least one inference concept based on the event data;
an evaluation unit communicatively coupled to the knowledge encoder unit and configured to process the at least one inference concept based on the semantic model to generate inferential data, wherein the inferential data is representative of an inference corresponding to the event data; and
an output unit communicatively coupled to the inference engine and configured to control the industrial application based on the inferential data.

11. The system of claim 10, wherein the plurality of concept rules is authored without using variables.

12. The system of claim 10, wherein the data input unit is configured to assist a subject matter expert in authoring a concept rule among the plurality of concept rules.

13. The system of claim 12, wherein the knowledge encoder unit is configured to incorporate the authored concept rule in the semantic model.

14. The system of claim 10, wherein the knowledge encoder unit is configured to translate one or more of the plurality of concept rules to a description logic representation.

15. The system of claim 14, wherein the knowledge encoder unit is configured to translate one or more of the plurality of concept rules to a semantic application design language (SADL), a PROLOG language, a target language, or combinations thereof.

16. The system of claim 15, wherein the target language comprises a Jena rules language.

17. The system of claim 10, wherein the output unit is configured to:
retrieve a recommendation corresponding to the event data from the inferential data based on desired inferential data; and
modify the event data based on the recommendation.

18. The system of claim 10, wherein the evaluation unit is configured to modify the semantic model based on the event data and the inferential data.

19. The system of claim 10, wherein the industrial application is one of a healthcare management system and a manufacturing system.

20. A non-transitory computer readable medium having instructions to enable at least one processor unit to:
receive event data corresponding to an industrial application;
generate at least one inference concept based on the event data;
obtain a semantic model comprising a plurality of inference concepts, a plurality of relationships among the plurality of inference concepts, and a plurality of concept rules representative of domain knowledge, wherein the plurality of concept rules is authored using the plurality of inference concepts and the plurality of relationships without using variables;
process the at least one inference concept based on the semantic model to generate inferential data, wherein the inferential data is representative of an inference corresponding to the event data; and
control the industrial application based on the inferential data.
